(19) United States
(12) Patent Application Publication
(10) Pub. No.: US 2006/0155762 A1
(43) Pub. Date: Jul. 13, 2006

(54) Systems and methods for single act media sharing

(75) Inventors: Prescott V. Lee, Menlo Park, CA (US); Kyle S. Mashima, Menlo Park, CA (US)

Correspondence Address: CARR & FERRELL LLP, 2200 GENG ROAD, PALO ALTO, CA, 94303, US

(73) Assignee: FilmLoop, Inc.

(21) Appl. No.: 11/173,255

(22) Filed: Jul. 1, 2005

Related U.S. Application Data
(60) Provisional application No. 60/644,254, filed on Jan. 13, 2005.
(60) Provisional application No. 60/644,129, filed on Jan. 13, 2005.

(51) Int. Cl. G06F 17/00; G06F 7/00

(52) U.S. Cl. 707/104.1

(57) ABSTRACT

A system and method for single act media sharing is provided. The method comprises receiving a media selection from a user. In response to a single act performed by the user, a first loop with an identifier is modified based on the media selection. The same identifier is assigned to the media selection. The media selection with the identifier is forwarded to a server that updates at least one second loop associated with one or more other users with the media selection based on the identifier in response to the single act performed by the user.

### CROSS-REFERENCE TO RELATED APPLICATIONS

The present application claims the benefit and priority of U.S. provisional patent application Ser. No. 60/644,254 filed on Jan. 13, 2005 and entitled “Systems and Methods for One Click Photo Sharing,” and U.S. provisional patent application Ser. No. 60/644,129, filed on Jan. 13, 2005 and entitled “Systems and Methods for Drag and Drop Loops,” which are herein incorporated by reference.

This application is related to co-pending U.S. application Ser. No. ___/___, entitled “Systems and Methods for Providing Loops,” filed on Jul. 1, 2005, co-pending U.S. application Ser. No. ___/___, entitled “Systems and Methods for Providing an Interface for Interacting with a Loop,” filed on Jul. 1, 2005, co-pending U.S. application Ser. No. ___/___, entitled “Systems and Methods for Single Input Installation of an Application,” filed on Jul. 1, 2005, co-pending U.S. application Ser. No. ___/___, entitled “Systems and Methods for Sharing Loops,” filed on Jul. 1, 2005, and co-pending U.S. application Ser. No. ___/___, entitled “Loop Channels,” filed on Jul. 1, 2005, which are herein incorporated by reference.

### BACKGROUND OF THE INVENTION

1. Field of the Invention

The present invention relates generally to media, and more particularly to systems and methods for single act media sharing.

2. Description of Related Art

In the modem electronic age, many people are accustomed to exchanging data in various manners. Users of computing devices share information via personal digital assistants (PDAs), cellular telephones (cell phones), laptop computers, and so on, for example. Information in the form of media is frequently shared among users so that they can present visual and/or audio media to other users. For example, a user can take a snapshot of a subject and send that snapshot to friends via the user's cell phone.

Conventionally, media is communicated from one user to another user through a series of steps. For instance, the user may access a file in a directory on the user's computing device to locate the media the user wishes to share with the other user. Once the user locates the media, the user typically right clicks on the media and selects an option, such as “send picture by electronic mail to”, in the case of an image. When the “send picture by electronic mail to” option is selected, an electronic mail window opens in which the user can enter text and select send to send the image to the other user. Alternatively, the user may open an electronic mail window and attach the image, or other type of media file, and send an electronic mail message along with the attachment to the other user. The process of communicating media from one computing device to another can take several minutes, because of the number of steps involved in locating, addressing, and sending the media to specified users.

However, with the improved performance of contemporary computing devices, users expect immediacy in sending and receiving media. While computing devices' performance is at an all-time high, users still require fewer steps for performing certain tasks. Therefore, there is a need for a system and method for single act media sharing.

### SUMMARY OF THE INVENTION

A system and methods for single act media sharing are provided. In one embodiment, the system comprises an identifier for identifying a first loop. A media engine is provided for receiving a media selection from a user and, in response to a single act performed by the user, modifying the first loop based on the media selection and forwarding the media selection. A server is provided for receiving the forwarded media selection and updating at least one second loop associated with one or more other users with the media selection in response to the single act performed by the user.

In another embodiment, the method comprises receiving a media selection from a user. In response to a single act performed by the user, a first loop is modified based on the media selection. The media selection is forwarded to a server that updates at least one second loop associated with one or more other users with the media selection in response to the single act performed by the user.

### BRIEF DESCRIPTION OF THE DRAWINGS

FIG. 1 illustrates an exemplary environment for providing single act media sharing in accordance with one embodiment;

FIG. 2 illustrates an exemplary diagram for a client having a media application in accordance with one embodiment;

FIG. 3 illustrates exemplary components associated with the server in accordance with one embodiment;

FIG. 4 illustrates an exemplary flow diagram for single act media sharing in accordance with one embodiment;

FIG. 5 illustrates another exemplary flow diagram for sharing media in response to the single act by the user in accordance with one embodiment;

FIG. 6 illustrates an exemplary graphical user interface in accordance with one embodiment; and

FIG. 7 illustrates an exemplary screen shot of a loop in accordance with one embodiment.

### DESCRIPTION OF EXEMPLARY EMBODIMENTS

A loop is provided for displaying media in association with a computing device related to a user. The user may select various media to display using the loop. In one embodiment, the loop comprises a Filmloop™. The loop may scroll the media across a display device associated with the computing device, or across any other display associated with any type of device. According to various embodiments, the media selected by the user for the loop may be shared with one or more other users at one or more other computing devices when the user drags the media to the loop, if the one or more other users share the same loop on their respective computing devices. Various other features associated with the loop are described herein.

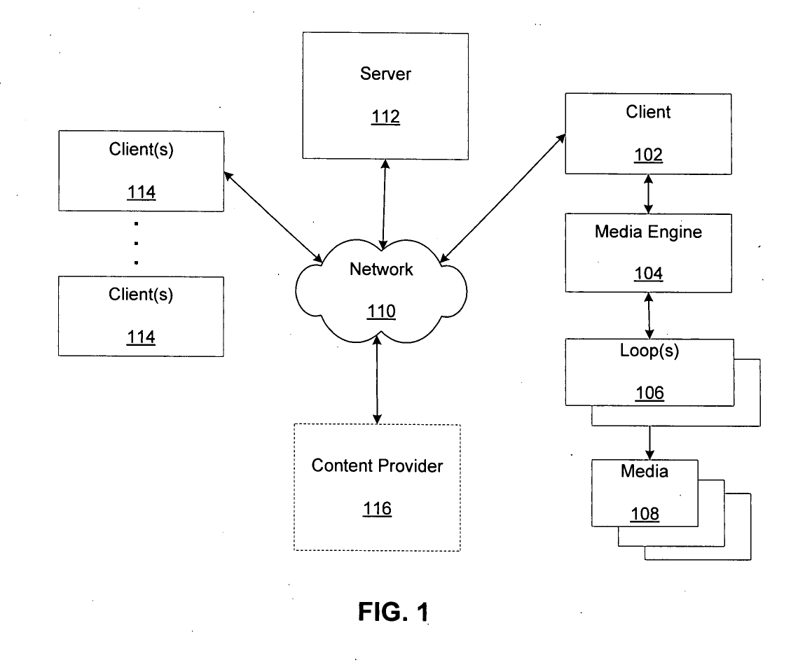

Referring to FIG. 1, an exemplary environment for providing single act media sharing is shown. A user is associated with a client 102. The client 102 includes any type of computing device, such as a cellular telephone, a laptop computer, a personal digital assistant (PDA), and so on. The client 102 has a media engine 104 coupled to the client 102 for creating and/or generating at least one loop 106. The media engine 104 may also play the loop 106. A loop player comprises the graphical representation of the media engine 104.

The loop 106 may be comprised of various media 108. The media 108 can include photos, video, audio, images, text, advertisements, and/or any other type of media. The media 108 may appear as one or more items separated by lines, frames, or any other display item for defining the one or more items of the media 108 as separate from each other on the loop. Each frame of the media 108 may itself include moving displays, motion pictures, and so forth.

In one embodiment, the loop 106 scrolls, or is otherwise played, across a display associated with the client 102. In some embodiments, the loop 106 may be manipulated by a user of the client 102 to stop, speed up, or slow down the scrolling of the loop 106, and/or any other type of manipulation. The client 102 may have more than one loop 106 that scrolls across the display at one time. Further, the client 102 may have various loop(s) 106 that play at one time and/or are stored at the client 102 to be played at a time chosen by the user associated with the client 102. The user may also play more than one loop 106, such as playing the loops 106 sequentially, in a single media engine 104.

The media engine 104 may reside on the client 102 or may be otherwise coupled to the client 102. Alternatively, the media engine 104 may be accessible to the client 102 via a network, such as the network 110 shown in FIG. 1. For example, one or more clients 102 may access the media engine 104 via a network in order to create the loop(s) 106, update the loop(s) 106 with additional media 108, remove certain of the media 108 from the loop(s) 106, alter metadata associated with the loop(s) 106, modify the media 108 or metadata associated with the media 108 contained in the loop(s) 106, play the loop(s) 106, and/or perform any other functions utilizing the media engine 104.

In exemplary embodiments, the identifier assigned to the media 108 may be unique within the loop(s) 106. Further, the loop(s) 106 identifier and/or the media 108 identifier is unique within the network 110, according to exemplary embodiments. Any type of identifiers may be assigned to the loop(s) 106 and/or the media 108 according to various embodiments.

The media engine 104 may be utilized, as discussed herein, to create the loop(s) 106 using the media 108. Typically, the user at the client 102 selects the media 108 from files located on the client 102 and/or from media 108 available via the network 110. For example, the user may search for and provide photos found on the Internet to the media engine 104. The media engine 104 receives the media 108 and creates the loop(s) 106 with the media 108. The user can provide more than one item of the media 108 to the media engine 104 for creating or modifying the loop(s) 106.

The user can provide the media 108 by dragging and dropping the media 108 into the media engine 104, by initiating a command that the media 108 be used to create a new loop(s) 106 and/or modify an existing loop 106, and/or any other method of identifying the media 108 as part of the loop(s) 106. In exemplary embodiments, the user can drag a folder including more than one item of the media 108 into the loop(s) 106.

The media engine 104 may assign an identifier to each of the loop(s) 106. The media engine 104 may further assign an identifier to each of the media 108 in the loop 106. For example, the media engine 104 may assign an identifier to a loop 106 that is newly created and may also assign identifiers to each of the media 108 used to create the new loop 106. In one embodiment, the media 108 may receive the same or similar identifier as the loop 106 to which the media 108 belongs.

The loop(s) 106 may be stored by category, dates associated with the media 108 included in the loop(s) 106, metadata associated with the loop(s) 106, or any other criteria. The criteria may be provided to the user as a default and/or the user can specify criteria for storing and/or playing the loop(s) 106. For example, in one embodiment, the user may specify that the loop(s) 106 should be played one at a time, one per day, according to a particular subject matter (e.g. such as family photo loop(s) 106, followed by fan club loop(s) 106, followed by work oriented loop(s) 106), and so forth. Any method for playing the loop(s) 106 is within the scope of various embodiments.

When the user drags and drops one or more items of the media 108 into a particular loop 106, the user is requesting that the media engine 104 modify the particular loop(s) 106 by adding the one or more items of the media 108. Accordingly, the media engine 104 assigns an identifier that is unique within the loop 106 to each of the items of the media 108 dropped by the user.

As discussed herein, the media 108 may be added to more than one loop(s) 106. Accordingly, the media 108 may have more than one identifier associated with the media 108 in order to identify the one or more loop(s) 106 which contain the media 108.

In order to add the media 108 to a loop 106 without using the drag and drop method, the user can identify the media 108 to be added and subsequently include the media 108 into the loop(s) 106 of the media engine 104. For example, the user may copy the media 108 from outside of the loop(s) 106. Subsequently, the user may paste the media 108 into the loop(s) 106. The user can identify the loop 106 according to the loop's 106 identifier, by subject matter, and/or by any other criteria that indicates to the media engine 104 which loop 106 should receive the media 108 being provided by the user.

The user can remove media 108 from a loop 106 by dragging the media 108 out of the loop 106, or identifying to the media engine 104 the media 108 to remove. Any manner of identifying the media 108 the user desires to remove from a loop 106 is within the scope of various embodiments. For instance, the user can highlight the item of the media 108 within the loop 106 and select a remove option from a drop down menu.

The media engine 104 updates the loop 106 to reflect the removal of the media 108. The media engine 104 may remove the identifiers associated with the removed media 108, or the media engine 104 can alter the metadata associated with the removed media 108. Conversely, as discussed herein, the user can add the media 108 back into a loop 106 by dragging and dropping the media 108 into the loop 106 to which the user wishes to add the media 108 or by identifying the media 108 to the media engine 104 that the user wishes to add to the loop 106.

In one embodiment, the identifiers for the loop(s) 106 and/or the media 108 may be assigned by a server 112, such as an “application server.” The server 112 may be accessed directly by the client 102 or via the network 110. The server 112 can communicate the identifiers for the loop(s) 106 and/or the media 108 to the media engine 104, so the media engine 104 can store and locate the identifiers.

When the user removes, adds, or modifies an item of the media 108 from the loop 106, the server 112 can store and/or track the removals, additions, and/or modifications as updates to the loop 106. The user can also update the loop 106 by making changes to items of the media 108 in the loop 106. For example, if the user resizes an image of the media 108, the media engine 104 and/or the server 112 can include the resized image as an update to the media 108 in the loop 106. In one embodiment, the server 112 may assign the identifier to the resized image in the media 108 and include the resized image as an update to the media 108 in the loop(s) 106. Any type of modifications to the media 108 and/or the loop 106 is within the scope of various embodiments.

In one embodiment, the user of the client 102 shares one or more of the loops 106 with one or more users of one or more other clients 114. The other clients 114 may also include one or more media engines for playing the loop(s) 106, creating the loop(s) 106, modifying the loop(s) 106, and so on. The server 112 assigns the same identifier to the loop(s) 106 shared by the client 102 and the client(s) 114.

When a user from the client 102 makes updates to the loop(s) 106 having an identifier shared by the loop(s) 106 at the client(s) 114, the client(s) 114 receive the same updates to the loop(s) 106. As discussed herein, the updates may include any modifications to the loop(s) 106 and/or the media 108 comprising the loop(s) 106.

The server 112 can provide the updates to the loop(s) 106 on the client(s) 114 automatically, at any time after the user at the client 102 makes updates to the loop(s) 106. In one embodiment, the server 112 makes requests to the media engine 104 at various times for changes made to the loop(s) 106 at the client 102. In one embodiment, the server 112 waits for notifications from the client(s) 114 of changes made to the loop(s) 106, then provides the updates to the client(s) 114 that have loops 106 with the same identifiers. Similarly, changes made by the client(s) 114 may be automatically provided to the client 102.

In one embodiment, the media engine 104 or any other component associated with the client 102 assigns a temporary identifier to the media 108 dragged into the loop 106. The client 102 then forwards the media 108 with the temporary identifier to the server 112. The server assigns a permanent identifier to the media 108 and forwards the media 108 with the permanent identifier back to the client 102 and/or to the other client(s) 114 as an update. The temporary identifier associated with the media 108 and/or the permanent identifier associated with the media 108 may further be associated with the identifier assigned to the loop(s) 106. Any type of method for assigning identifiers to the media 108 and/or the loop 106 may be employed by any device according to various embodiments.

The one or more users at the client(s) 114 may also make updates to the loop(s) 106 that have the same identifiers as the loop(s) 106 at the client 102. In one embodiment, the user that originates a shared loop 106 can create permissions for the loop 106. For instance, the originating user may require a password before other users can submit updates to the shared loop(s) 106.

Since the server 112 may automatically distribute the updates to the client(s) 102 and 114 with loop(s) 106 that have shared identifiers, only a single act is required by the user to share the updates to the loop(s) 106 with the users at the client(s) 102 and 114.

In one embodiment, users may subscribe to loop(s) 106. For example, the user at the client 102 may post movie oriented loop(s) 106 to the Internet and other users may subscribe to those movie oriented loop(s) 106 via a registration process. For the users that subscribe to the movie oriented loop(s) 106, updates are received when the originating user makes modifications to the movie oriented loop(s) 106. As discussed herein, a user, vendor, retailer, advertiser, etc. may make loop(s) 106 available for subscription.

Once the loop(s) 106 have been set up by various users and assigned unique identifiers, the server 112 and/or the media engine 104 keeps track of the loop(s) 106 and any changes thereto. Accordingly, since the server 112 automatically distributes, or otherwise distributes, the updates to the client(s) 114 with the loop(s) 106 with shared identifiers based on the user at the client 102 modifying the loop(s) 106 by adding, removing, or changing one or more items of the media 108 within the loop(s) 106, only a single act is required by the user to share the updates to the loop(s) 106 with the users at the client(s) 114.

In one embodiment, master copies of the loop(s) 106 may be stored on the server 112. Accordingly, the user at the client 102 can modify the loop(s) 106 by accessing the server 112. The user may access the server 112 via the network 110 or in any other manner. Alternatively, the server 112 may include an index for locating the various loop(s). In another embodiment, the loop(s) 106 may be stored at the server 112, while the client 102 and/or the client(s) 114 utilize an index to retrieve particular loop(s) 106 when desired. Any storage medium may be utilized for storing the loop(s) 106, copies of the loop(s) 106, metadata, and/or indexes according to various embodiments.

In another embodiment, the server 112 may store the master copies of all the loop(s) 106 for all users along with the identifiers for the loop(s) 106 and the media 108. Accordingly, the server 112 can search for loop(s) 106 based on the identifiers, receive updates to the loop(s) 106 when users associated with the loop(s) 106 makes changes to the loop(s) 106, and automatically distribute updates for the loop(s) 106 to all user associated with the loop(s) 106. In still another embodiment, the loop(s) 106 may be stored on the server 112 in order to minimize storage on the client 102 and/or the client(s) 114, as discussed herein.

In still another embodiment, the server 112 may store versions of the loop(s) 106. Accordingly, the server 112 may maintain various copies of the same loop(s) 106, as different versions. According to another embodiment, the client 102 and/or 114 may store different versions of loop(s) 106 generated by the client 102 or of shared loop(s) 106. The server 112 and/or the client 102 may maintain an index for organizing and tracking the various versions of the loop(s) 106 according to some embodiments.

In one embodiment, a content provider 116 is coupled to the server 112 in order to provide content for the loop(s) 106. The content provider 116 may be directly coupled to the server 114 or the content provider 116 may be coupled to the server 112 via the network 110. In one embodiment, the content provider 116 is coupled to the client 102 and/or the client(s) 114 in order to directly provide the content to the loop(s) stored on the client 102 and/or the client(s) 114.

In exemplary embodiments, the content provider 116 provides advertising content to the loop(s) 106. Alternately, the content provider 116 may provide any type of content. In one embodiment, each of the loops 106 must include at least one item of the content from the content provider 116. More than one content provider 116 may be provided according to various embodiments. Accordingly, the loop(s) 106 may display advertisements or other content along with the other media 108 displayed by the loop(s) 106.

In one embodiment, the content provider 116 can specify how often the content appears within the loop(s) 106. For example, the content provider 116 may specify that the content should appear no less than between every 10^{th} item of media 108 within the loop(s) 106. If the content provider 116 modifies the content, the server 112 or the content provider 116, itself, can distribute the modified content as updates to the loop(s) 106. Accordingly, the modified content replaces the existing content in the loop(s) 106.

In one embodiment, digital content may be emailed to a central authority associated with the loop(s) 106. The central authority may then authenticate the user and distribute the digital content to appropriate loop(s) 106 and/or create new loop(s) 106 based on the digital content. The authentication may be based on username, password, and/or any other information related to the user submitting the digital content.

Although the media engine 104 at the client 102 is described as creating the loop(s) 106 from the media 108, one or more media engines at the client(s) 114 can also provide the media 108 and create the loop(s) 106, modify the loop(s) 106, and so on. In other words the client 102 and the client(s) 114 are capable of performing similar or identical functions with respect to the loop(s) 106.

The process of providing loops is described in further detail in co-pending U.S. application Ser. No. ___/___, entitled “Systems and Methods for Providing Loops,” filed on Jul. 1, 2005, which is incorporated by reference.

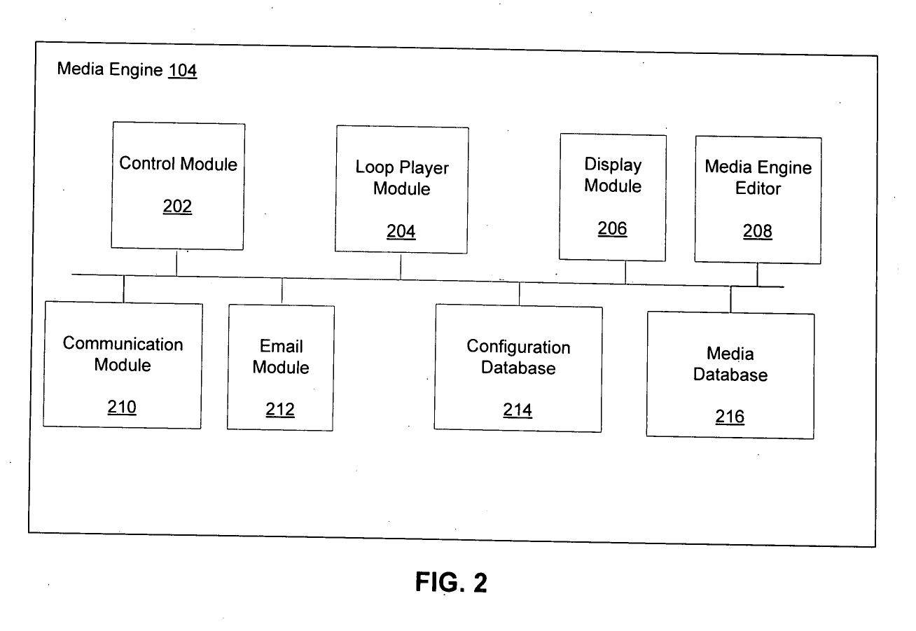

Referring to FIG. 2, a diagram for an exemplary media engine 104 is shown. A loop control module 202 manipulates the media 108 (FIG. 1) and constructs the loop(s) 106 (FIG. 1) from the media 108. The loop(s) control module 202 provides a default speed at which the loop(s) 106 plays. In a further embodiment, a user can specify the speed for playing the loop(s) 106 or adjust the speed from the default speed. The loop control module 202 may coordinate with the content provider 116 (FIG. 1) to insert specific content into the loop(s) 106 at specific times or in specific time intervals.

A player module 204 plays the loop(s) 106. The player module 204 may be utilized to control a direction and a speed at which the loop(s) 106 plays. The player module 204 may have a default direction, which may be changed by the user.

A display module 206 provides a graphical user interface (GUI) for allowing the user to interact with logic of the media engine 104. For instance, the display module 206 allows the user to interact with the media engine 104 to read and write the media 108. In other words, the display module 206 allows the user to create, modify, and/or remove the media 108 and/or the loop(s) 106 by choosing from on-screen selections and/or manipulating on-screen items. The display module 206 may also execute the media 108 from within a window, display the media 108 alone or as part of the loop(s) 106, and/or perform any functions related to display and user interaction with the display.

As discussed herein, the display module 206 allows the user to drag and drop the media 108 into the loop(s) 106 and remove the media 108 from the loop(s) 106. The user can drag and drop the media 108, click a button, or initiate a voice command to send the media 108 changes to the media engine 104.

Any type of display module 206 is within the scope of various embodiments. For instance, the display module 206 need not present a typical visual display, but may be a text-based display module for allowing the user to interact with logic of the media engine 104 based on text command lines.

A media engine editor 208 allows the user to make adjustments to the media 108. For example, the user can use the media engine editor 208 to resize the media 108, rotate the media 108, configure the media 108, format the media 108, and so forth. For instance, the user may-resize an image or change a font type of text associated with the media 108. Any type of editing may be accomplished using the media engine editor 208.

A communication module 210 allows the media engine 104 to utilize components of the client 102 for communicating with the server 112 to send and receive updates for the loop(s) 106 running in the media engine 104, and to transfer any other data between the media engine 104 and the server 112.

An electronic mail interface 212 may be provided as a communications interface for electronic mails. Any type of electronic mail interface 212 may be provided. The electronic mail interface 212 may be utilized for sending the loop(s) 106, the media 108, metadata, or identifiers associated with the loop(s) 106 and/or the media 108 directly to other users.

A configuration database 214 may be utilized to store the one or more identifiers associated with the media 108 and/or the loop(s) 106. As discussed herein, when the loop(s) 106 is created using the media 108 or updates to the loop(s) 106 are provided, an identifier is assigned to the loop(s) 106 or the media 108. In further embodiments, the media 108 in the loop(s) 106 is assigned an identifier that is unique within the loop(s) 106.

The configuration database 214 may store any type of data related to the loop(s) 106, such as information regarding a host computer system, type and quality of an attached network, communications performance, registration information for the client 102, version number for the loop(s) 106 and the media 108 comprising the loop(s) 106. Any type of configuration database 214 may be utilized in accordance with various embodiments. As discussed herein, in one embodiment, the identifier is stored on the server 112 and/or in the configuration database 214. In alternative embodiments, the configuration database 214 may comprise more than a database. In yet a further embodiment, the configuration database 214 may be located outside the media engine 104, but be coupled thereto. It should be noted that the configuration database 214 and the media database 216 may comprise a single database.

A media database 216 may be provided for storing the media 108. In one embodiment, the content from the content provider 116 is stored in the media database 216. Any process for storing the media 108 may be utilized in association with the media database 216. For example, a hash function may be utilized to index and retrieve the media 108 in the media database 216 or from one or more other storage mediums.

Although the media engine 104 is described as including various components, the media engine 104 may include more components or fewer components than those listed and still fall within the scope of embodiments of the invention. For example, the media engine 104 may also include a media cache/buffer for short term storage of the media 108, an input/output (I/O) component for receiving and sending data at the client 102, a contact database for storing information associated with contacts, a user activity component for tracking activity of the user with respect to the media 108 and/or the loop(s) 106, and so forth.

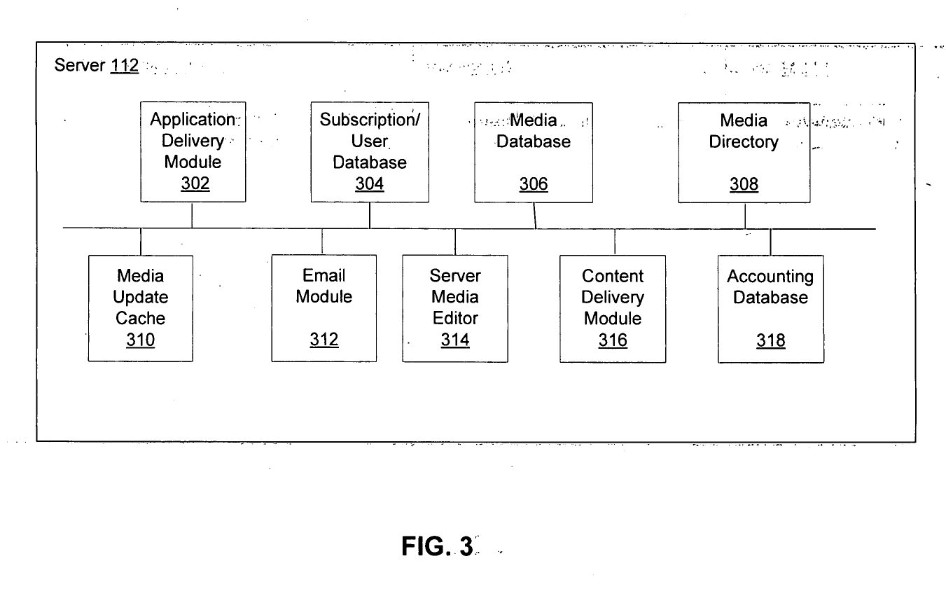

FIG. 3 illustrates exemplary components associated with the server 112 in accordance with one embodiment. A delivery module 302 may be provided for delivering the loop(s) 106 (FIG. 1), and the media 108 (FIG. 1) that comprise the loop(s) 106, as well as the identifiers assigned to the loop(s) 106 and the media 108 to clients.

In one embodiment, the media 108 is provided to the media engine 104 for creating the loop(s) 106. The media engine 104 then requests the server 112 create the loop(s) 106 with the media 108. Alternatively, as discussed herein, the media engine 104, itself, may create the loop(s) 106. The server 112 and/or the media engine 104 can assign an identifier to the loop(s) 106 and to each of the one or more items of media 108 comprising the loop(s) 106. If the server 112 creates the loop(s) 106 or maintains a master copy of the loop(s) 106, the server 112 can deliver the loop(s) 106 to the media engine 104 via the network 110, as discussed herein. However, any manner of delivering the loop(s) 106 to the media engine 104 is within the scope of various embodiments.

A user database 304 may be provided for storing user information, such as first and last names, electronic mail addresses, user identifiers, and so on. The user database 304 may also store information associated with the loop(s) 106 that the user created or received from other users. Based on the identifiers from the loop(s) 106, the user database 304 can provide the media 108 as updates to the appropriate loop(s) 106 in the loop players 104 running on the client 102 or the client(s) 114. Optionally, a user may be required to register certain information with the server 112 before the server 112 will provide the loop(s) 106 with the media 108 to the loop player(s) 202 (FIG. 2) associated with the user. Alternatively, the user may be required to register in order to receive the identifier for the media 108 and/or the loop(s) 106.

A media database 306 may also be provided for storing the media 108 the loop(s) 106 and/or any metadata or configuration information associated with the loop(s) 106 and/or the media 108. As discussed herein, the media 108 and/or the loop(s) 106 may include, for example, multimedia, photographs, sounds, music, pictures, streaming media, animation, movies, and graphics. Any type of media 108 may comprise the loop(s) 106.

A media directory 308 may be provided for indexing the media 108 stored in the media database 306. For example, in one embodiment, the media directory 308 may allow the loop(s) 106 and/or media 108 to be retrieved that have the word “fishing” in their titles or descriptions. Any indexing and searching by the media directory 308 on any information or metadata associated with the loop(s) 106 or the media 108 is within the scope of various embodiments.

A media update cache 310 stores the media 108 that is utilized to update, or otherwise modify, the loop(s) 106.

An electronic mail module 312 sends electronic mail for the user at the client 102 to the one or more other users at the client(s) 114, providing the users at the client(s) 114 with information for retrieving or constructing the loop(s) 106 and/or the media engine 104.

A server media editor 314 may be provided for modifying the media 108. The user can modify the media 108 utilizing the server media editor 314 via the server 112 rather than, or in addition to, the media engine editor 208 (FIG. 2). For example, the server media editor 314 may be used to resize photos, rotate photos, remove red eye from photos, correct color balance, cleanse the media 108 of viruses, and so forth.

As discussed in FIG. 1, a content provider 116 may be coupled to the server 112. Alternatively, the function of the content provider 116 may be performed by a content delivery module 316 within the server 112. The content delivery module 316 provides advertising and/or any other type of content to be included as one or more items of the media 108 within the loop(s) 106.

In one embodiment, the advertising and/or content from the content delivery module 316 may be provided based on an analysis of the user of the loop(s) 106. For example, an advertisement for toothpaste may be provided to a user with family related loops 106. However, any manner of determining the advertising and/or the content to be provided by the content delivery module 316 to the loop(s) 106 may be employed, such as arbitrarily choosing the advertising and/or the content.

In one embodiment, the media 108 may comprise more than one advertising media inserted into the loop(s) 106. As discussed herein, the content provider 116 and/or the content delivery module 316 may dictate how frequently the advertising media, or other content, appears. For instance, the advertising media may appear twice in the loop(s) 106, once for every five items of the media 108 in the loop(s) 106, and so on.

A commercial loop(s) 106 may also be created utilizing the content delivery module 316. The commercial loop(s) 106 may include media with embedded music, streaming video, audio, and/or other multimedia effects. A user may choose to allow the commercial loop(s) 106 to play on a display device associated with the user's client 102.

The server 112 may also include an accounting module 318. The accounting module 318 can track the media 108 within the loop(s) 106, and track the frequency and type of interaction each of the users has with the loop(s) 106 on the media 108. Specifically, the accounting module 318 is useful for tracking the interaction between the user and the advertisement media included within the loop(s) 106. Accordingly, the accounting module 318 can track monies due to a provider of the advertising media based on user interaction with the advertising media.

Although the server 112 has been described as including various components, fewer or more components may comprise the server 112 in accordance with various embodiments. For instance, the server 112 may also include a search engine component, or a communications interface.

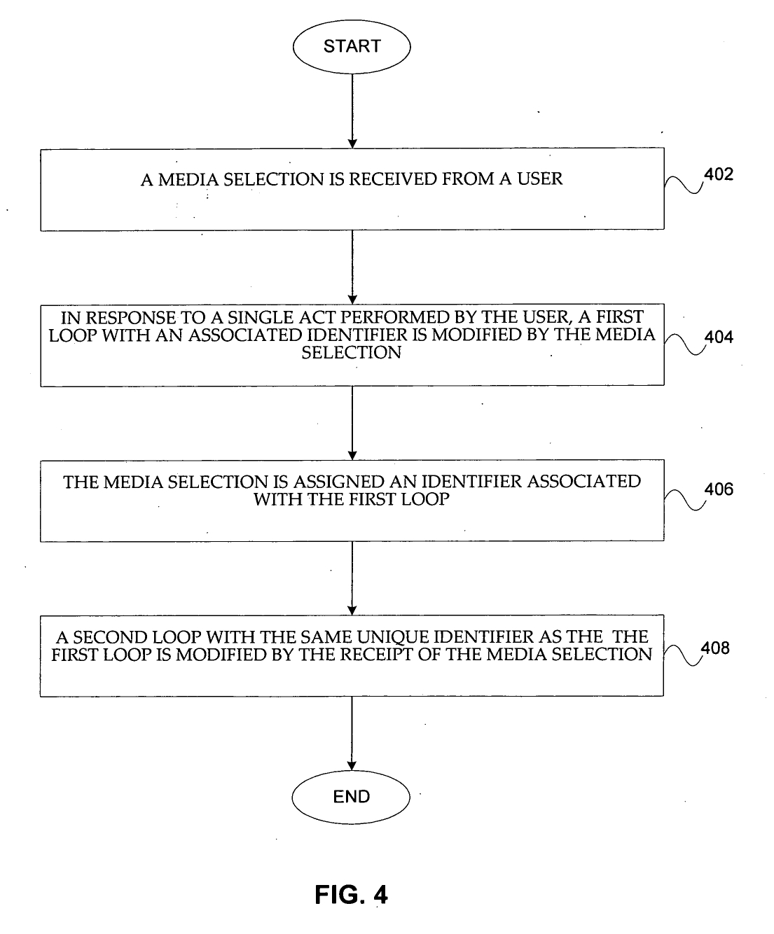

FIG. 4 illustrates an exemplary flow diagram for single act media sharing. At step 402, a media selection is received from a user. The media selection may include adding new media, removing media, or modifying existing media, such as the media 108 discussed in FIG. 1

At step 404, in response to a single act performed by the user, a first loop having an identifier is modified by the media selection. As discussed herein, the user may initiate the single act via a button, a keystroke, a voice command, a drag and drop operation, and so forth. Any single act by the user for providing the media selection is within the scope of various embodiments. The user may provide the media selection to a loop player, such as the media engine 104 discussed in FIG. 1.

At step 406, the media selection is assigned the identifier assigned to the first loop. The identifier assigned to the media selection may also be unique within the first loop. By assigning the identifier to the media selection that is unique within the first loop, the media engine 104 and/or the server 112 can associate the media selection with the first loop and any other loops sharing the identifier.

At step 408, the media selection is forwarded to a server that modifies a second loop with the same identifier as the identifier assigned the first loop. In other words, the single act of the user sending the media selection to the media engine 104 shares the media selection with other users having second loops with identifiers shared with the first loop, once the other users download the updates from the server. As discussed herein, the client 102 may notify the server 112 of updates to the loop(s) 106, the server 112 may periodically check for updates, the other client(s) 114 may periodically request updates, and so forth. Any manner of obtaining and forwarding the updates is within the scope of various embodiments. For example, the client 102 may forward updates directly to the other client(s) 114 based on a notification from the server 112 that the other client(s) 114 need the updates.

In another embodiment, the server 112 may maintain an index of the loop(s) 106. When an update occurs, the server 112 may retrieve the update from the client 102 and forward the update to the other client(s) 114 or direct the client 102 to forward the update to the other client(s) 114. According to another embodiment, the client 102 and/or the client(s) 114 may include server oriented devices that can check for and forward the updates to the loop(s) 106 directly from the client 102 to the other client(s) 114 and vice versa.

In exemplary embodiments, the user at the client 102 provides the media selection, such as the media 108 discussed in FIG. 1, to the media engine 104. The media engine 104 creates two copies of the media selection and saves, and/or caches, the two copies of the media selection. Either or both copies of the media selection may be saved to a storage medium, such as the media database 216 discussed in FIG. 2. Optionally, only one copy of the media selection is saved and/or cached.

The media engine 104 displays the first media selection on a screen associated with the client 102 as part of the loop(s) 106 being played. The media engine 104 creates and sends a second copy of the media selection to a server, such as the server 112 discussed in FIG. 1. The server 112 stores the second copy of the media selection in the media directory 308 (FIG. 3) and/or in the media update cache 310. The server 112 sends the second copy of the media selection to other users associated with the client(s) 114 if the identifier associated with the media selection (i.e., the copies of the media selection) and/or the first loop matches the identifier associated with the second loop(s) 106 at the client(s) 114. As discussed herein, according to some embodiments, the server 112 may assign a permanent identifier to the media selection to replace the temporary identifier assigned to the media section by the client 102.

As discussed herein, the server 112 can create and send the second copy of the media selection to the client(s) 114 automatically, or in response to requests from the client(s) 114 for the second copy of the media selection (i.e. the updates to the second loop(s) 106). Accordingly, the second loop(s) 106 is modified in response to a single action, or single act, by the user at the first client 102 interacting with the first loop(s) 106.

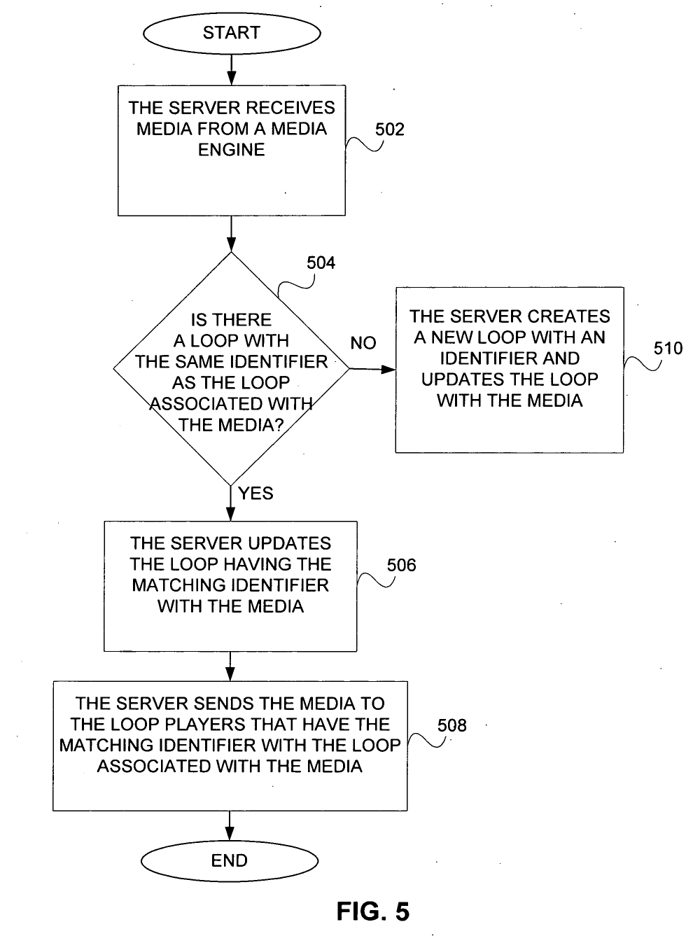

Referring to FIG. 5, another exemplary flow diagram for sharing media in response to the single act by the user is shown. At step 502, the server 112 receives one or more items of the media 108 from the media engine 104.

At step 504, the server 112 determines whether there is an existing loop(s) 106 with an identifier that matches the identifier associated with the media 108.

At step 506, if there is an existing loop(s) 106 that matches the identifier associated with the media 108, the server 112 updates the loop(s) 106 having the matching identifier with the media 108.

At step 508, the server 112 sends the media 108 with the matching identifier for the loop(s) 106 to the client(s) 114 making the requests for the updates. As discussed herein, the loop(s) 106 associated with the client(s) 114 is then updated with the media 108 having the matching identifier. Further, the media 108 may be forwarded to the client(s) 114 as updates based on requests from the client(s) 114 for updates, periodic pushes from the server 112 of updates, and/or notification by the client 102 that updates have occurred.

The process of sharing loops is described in further detail in co-pending U.S. application Ser. No. ___/___, entitled “Systems and Methods for Sharing Loops,” filed on Jul. 1, 2005, and co-pending U.S. application Ser. No. ___/___, entitled “Loop Channels,” filed on Jul. 1, 2005, which is incorporated by reference.

If, at step 504, the server 112 determines that there is not a loop(s) 106 with an identifier that matches identifier of the loop(s) 106 with the media 108, the server 112, at step 510, creates a new loop(s) 106 and assigns the same identifier to the new loop 106 and updates the new loop(s) 106 with the media 108. As discussed herein, the server 112 may communicate the identifier to the configuration database 214 at the first client 102 for storage and/or reference.

In one embodiment, the media engine 104 assigns the same identifier to the media 108 and the new loop(s) 106 and communicates the identifier assigned to the server 112. The media engine 104 stores the identifier in the media database 216 or in the configuration database 214.

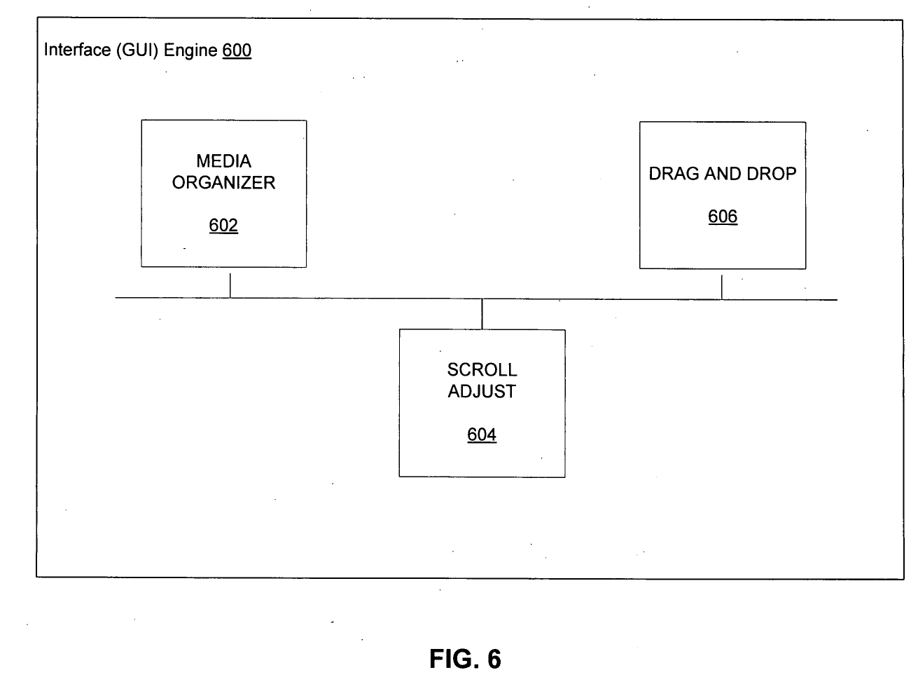

Turning now to FIG. 6, an exemplary graphical user interface (GUI) engine 600 for providing access to functions related to the media engine 104 (FIG. 1) is shown. In one embodiment, the GUI engine 600 is the display module 206 (FIG. 2). A media organizer 602 allows a user to organize the media 108 (FIG. 1) in the loop(s) 106 (FIG. 1). For example, the user can provide photos to the media organizer 602 via a drag and drop function, a keystroke, etc., and the media organizer 602 can automatically organize the photos according to default parameters or parameters specified by the user. The default parameter may be, for instance, to organize the photos according to dates associated with the photos. The user can specify any parameters, such as date, size, event, and so forth, for the media organizer 602 to use in arranging the media 108.

A movement controller 604 provides the user with a mechanism to regulate the pace of the loop(s) 106, as discussed herein, as it scrolls across a display device associated with the client 102. For example, the user may specify that the loop(s) 106 should scroll across the display device at a rate of one display device pixel per tenth of a second. The movement controller 804 also allows the user to specify the direction the loop(s) 106 should scroll across the display device of the client 102. For example, the user may specify that the loop(s) 106 should scroll left to right across the display device. Any manner of allowing the user to adjust the pace may be provided. For instance, the user may enter the scroll time into a box, move a slider between a slowest pace and fastest pace, select from scroll paces from a drop down menu, and so on.

A drag/drop manager 606 provides a mechanism for the user to modify the loop(s) 106 in a single drag and drop action. Thus, the user can drag one or more items of the media 108 into the loop(s) 106. The drag/drop manager 606 communicates the user action and information to other components/modules associated with the media engine 104 for automatically updating the loop(s) 106 to include the dropped media 108. As discussed herein, when the user performs this single act of dragging and dropping the media 108 into the loop(s) 106, one or more other loop(s) 106 that share the identifier are also updated with the dropped media 108. As discussed herein, the other loop(s) 106 may reside in other media engines 104 (FIG. 1) at the client(s) 114. Conversely, the user can drag one or more items of the media 108 away from the loop(s) 106, in order to remove the items. The loop(s) 106 that share the same identifier are also updated to no longer include the media 108 dragged away from the loop(s).

A scroll adjust 608 option may also be provided via the GUI engine 600. The scroll adjust 608 allows the user to manipulate the loop(s) 106 as they scroll across a display device. For instance, as the loop(s) 106 scrolls across the display device, the user can grab the loop(s) 106 with a mouse, keystroke, etc., and move the loop(s) 106. The user can stop the scrolling, slow down the scrolling, speed up the scrolling, and so forth by clicking on, moving, etc. the loop(s) 106, itself. The user can choose which of the loop(s) 106 and/or how many of the loop(s) 106 the user wants to scroll on the user's display device at one time.

Although an exemplary graphical user GUI engine 600 has been described, any type of graphical user interface engine with any type of functionality is within the scope of various embodiments. For example, the GUI engine 600 may include mechanisms for allowing functionality such as creating another loop when the user selects the one or more items of the media 108 comprising the loop(s) 108, displaying a larger image when the user selects the one or more items of the media 108 in the loop(s) 108, dragging and dropping the entire loop(s) 108 from one media engine 104 to another media engine 104, creating a new empty loop 108 from when the user selects an item of the media 108 in the loop(s) 108, sending an electronic mail message to other users that contains a copy of the entire loop(s) 108 or information related to specific loops 108, providing the ability to search for various loops 108 associated with the client 102, client(s) 114, and/or stored in a publicly accessible media directory 608, and so forth.

The process of providing an interface for interacting with a loop is described in further detail in co-pending U.S. application Ser. No. ___/___, entitled “Systems and Methods for Providing an Interface for Interacting with a Loop,” filed on Jul. 1, 2005, which is incorporated by reference.

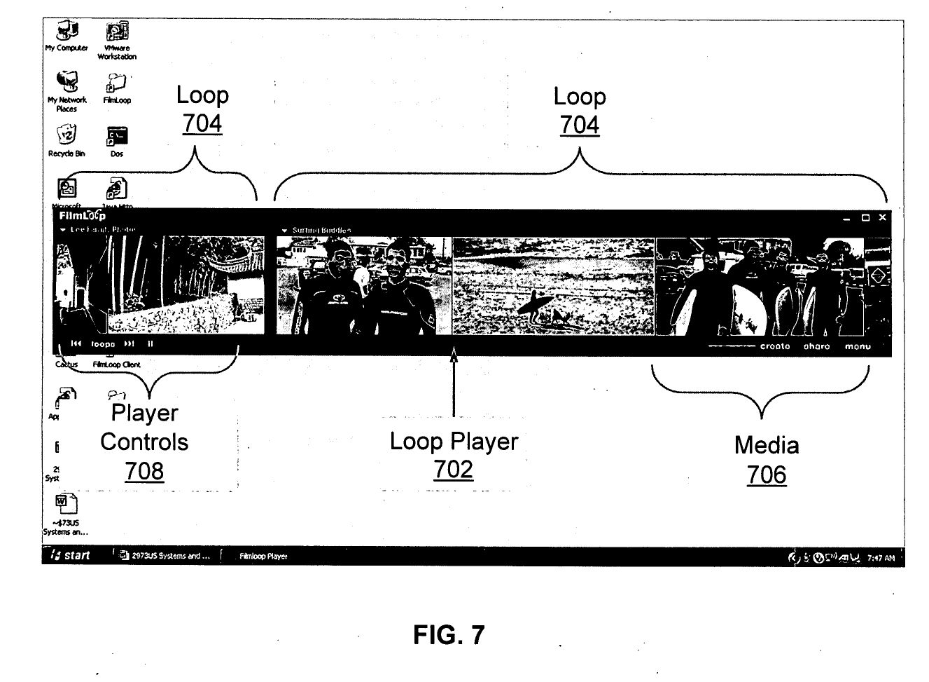

Referring now to FIG. 7, a screen shot of an exemplary loop 704, such as the loop(s) 106 discussed in FIG. 1, in accordance with one embodiment is shown. A loop player 702, such as a graphical representation of the media engine 104 discussed in FIG. 1, includes several loops 704. Each loop 704 includes several items of media 706, such as the one or more items of the media 108 discussed in FIG. 1. The loop player 702 plays the loop 704 by scrolling the various media 706 across a display device. The display device in FIG. 7 is a desktop display.

In FIG. 7, the loop player 702 is displaying two loops 204, one entitled “Lee Family Photos” and the other entitled “Surfing Buddies.” As shown, one item of the media 706 in the “Surfing Buddies” loop 704 is a picture of four surfers. As discussed herein, various types of media 706 may be included in the loop(s) 704, such as the photograph of the four surfers, advertising content from a content provider, such as the content provider 116 discussed in FIG. 1, and so on. Although FIG. 7 shows two loops 704 adjacent to one another being played by the same loop player 702, a single loop 704 may scroll across a display device associated with a user according to various embodiments. In one embodiment, the user may scroll more than one loop 704 across the display device at different locations on the display device, rather than adjacent loops 704 played in one loop player 702, as discussed herein. Further, more than one loop 704, including adjacent loops 204 played by one loop player 702, may scroll across the display device of the user.

The loop player 702 may scroll the media 706 for the loop 704 across the display device at any speed and/or in any direction. The speed and/or direction may be a default speed, a default direction, and/or a direction and/or speed specified by the user. In one embodiment, the content provider 116 specifies the speed in order to ensure that the content provided appears at specified increments of time. In a further embodiment, the server 112 may also specify the speed and/or the direction.

The user may utilize player controls 708 to adjust the speed, the media 706 to display, and so on. For instance, the user can skip to a previous or next item of the media 706 by utilizing the player controls 708. The user can also pause the scrolling loop(s) 704. Furthermore, the user can stop the loop 704, reduce or expand the size of the loop 704, or minimize the loop 704. In one embodiment, the user may access a master set of controls that control more than one loop 704. In another embodiment, when the user adjusts the player controls 708 associated with the loops 204, other users' loop(s) 704 with the same unique identifier are automatically adjusted as well.

The media 706 in the loop 704, can be dragged away, or otherwise removed, from the loop 704 by a user, as discussed herein. When the user removes one or more of the items of the media, the loop player 702 updates the loop 704 to no longer include the one or more items of the media 108 that the user removed. The loop player 702 may also forward the update to a server, such as the server 112 described in FIG. 1. The server 112 may subsequently update the other users' loop(s) 106 that share the same identifier, with the removal of the one or more items of the media, in response to the single act by the user of removing the one or more items of the media from the user's loop 704. However, any manner of updating the loop(s) 106 is within the scope of various embodiments.

In order to drag the loop 704 and/or the loop player 702 to other areas of the display device, the user can grab the loop player 702 and move it to the desired area using a mouse, a keyboard, or any other coupled control device. The user can incorporate the loop 704 into a second loop, such as the loop(s) 106 discussed herein, by dragging and dropping the loop 704 into the second loop(s).

The user can drag the media 706 from the loop 704 to a second loop to modify the second loop with the media 706 that was dragged into the second loop. In one embodiment, the user may select from a drop down menu to copy and/or move the media 706 to another loop.

In one embodiment, the user may select a single frame from of the media 706, such as the photo of the four surfers, in order to “open” the single frame or load a new loop associated with the single frame. Opening the single frame of the media 706 may enlarge the content that comprises the single frame, display an alternate version of the media 706 that comprises the single frame, make the content available for editing, stop the single frame content from moving (in the event of moving displays), direct the user to a URL address, and so on.

Opening the single frame of the media 108 may also present a new loop, or “sub loop”, associated with the single frame of the media 706. For instance, if a user associated with the loop 704 selects the frame with the photo of the four surfers in the media 706 in the “Surfing Buddies” loop 704, a new loop with more surfing buddies photos and/or content may be revealed. Opening a single frame of the media 706 in a loop 704 having an advertisement may reveal a new loop with content provided solely by a content provider, such as the content provider 116 discussed in FIG. 1. Any type of new loop may be provided as a consequence of opening the single frame of the media 706.

In one embodiment, when the user selects a single frame of the media 706, the loop player 702 makes a request to a client (e.g., such as the client 102 and/or the client(s) 114), to launch a particular application running on the client 102 and/or the client(s) 114. For example, when a particular frame of the media 706 in the loop 704 is selected, the loop player 702 instructs a web browser installed on the client 102 to display a particular web page. The web page may be associated with subject matter for the single frame of the media 706.

In one embodiment, opening a single frame of the media 706 may provide an additional option of sending the single frame of the media 706 to one or more other users. For example, although two users may not share the loop(s) 704 with the same unique identifier, the two users may maintain the loop(s) 704 with similar subject matter. Accordingly, the users may send one or more of the single frames of the media 706 to one another in order to update content, inform one another of advertising, etc.

One or more of the frames of the media 706 can be shared between any users for any reason. In one embodiment, the content provider 116 (FIG. 1) pushes time sensitive information to users of the loop(s) 106 as one or more frames of the media 706. Any type of information may be provided to users of the loop(s) 704, such as news, financial data, sales information, new product offerings, single frames of the media 706 from other loop(s) 704 users, and so on. In one embodiment, the users of the loop(s) 704 can block single frames of the media 706 from being presented.

The above-described functions can be comprised of instructions that are stored on a storage medium. The instructions can be retrieved and executed by a processor. Some examples of instructions are software, program code, and firmware. Some examples of storage medium are memory devices, tape, disks, integrated circuits, and servers. The instructions are operational when executed by the processor to direct the processor to operate in accord with the invention. Those skilled in the art are familiar with instructions, processor(s), and storage medium.

While various embodiments have been described above, it should be understood that they have been presented by way of example only, and not limitation. For example, any of the elements associated with the loop(s) may employ any of the desired functionality set forth hereinabove. Thus, the breadth and scope of a preferred embodiment should not be limited by any of the above-described exemplary embodiments.

What is claimed is:

1. A method for single act media sharing, comprising:
receiving a media selection from a user;
in response to a single act performed by the user, modifying a first loop with the media selection; and
forwarding the media selection to a server that updates at least one second loop associated with one or more other users with the media selection in response to the single act performed by the user.

2. The method recited in claim 1, wherein the media selection includes removal of one or more items of media comprising the first loop.

3. The method recited in claim 1, wherein the media selection includes addition of one or more items of media to the first loop.

4. The method recited in claim 1, wherein the media selection includes modification of one or more items of media comprising the first loop.

5. The method recited in claim 1, wherein the server updates the at least one second loop based on requests for updates associated with the second loop.

6. The method recited in claim 1, wherein the single act includes dragging and dropping the selected media into the first loop.

7. The method recited in claim 1, wherein the single act includes an audio instruction.

8. The method recited in claim 1, wherein the single act includes clicking a button.

9. A system for single act media sharing, comprising:
a first loop;
a media engine for receiving a media selection from a user and in response to a single act performed by the user, modifying the first loop based on the media selection and forwarding the media selection; and
a server for receiving the forwarded media selection and updating at least one second loop associated with one or more other users with the media selection in response to the single act performed by the user.

10. The system recited in claim 9, further comprising a button for enabling the single act media sharing.

11. The system recited in claim 9, further comprising an audio recognition component for enabling the single act media sharing via an audio instruction.

12. The system recited in claim 9, wherein the media selection is received via a drag and drop operation.

13. The system recited in claim 9, wherein the media engine assigns the identifier to the first loop and the media selection.

14. The system recited in claim 9, wherein the server assigns the identifier to the first loop, the at least one second loop, and the media selection.

15. A computer program embodied on a computer readable medium for single act media sharing having instructions for:
receiving a media selection from a user;
in response to a single act performed by the user, modifying a first loop with the media selection; and
forwarding the media selection to a server that updates at least one second loop associated with one or more other users with the media selection in response to the single act performed by the user.

16. The computer program recited in claim 15, wherein the media selection includes removal of one or more items of media comprising the first loop.

17. The computer program recited in claim 15, wherein the media selection includes addition of one or more items of media to the first loop.

18. The computer program recited in claim 15, wherein the media selection includes modification of one or more items of media comprising the first loop.

19. The computer program recited in claim 15, wherein the server updates the at least one second loop based on requests for updates associated with the second loop.

20. The computer program recited in claim 15, wherein the single act includes dragging and dropping the selected media into the first loop.

21. The computer program recited in claim 15, wherein the single act includes an audio instruction.

22. The computer program recited in claim 15, wherein the single act includes clicking a button.
